(19) United States
(12) Patent Application Publication
(10) Pub. No.: US 2024/0354974 A1
(43) Pub. Date: Oct. 24, 2024

(54) SYSTEMS AND METHODS FOR AUGMENTING IMAGES DURING TRAINING OF A DEPTH MODEL

(71) Applicant: Toyota Research Institute, Inc., Los Altos, CA (US)

(72) Inventors: Vitor Campagnolo Guizilini, Santa Clara, CA (US); Igor Vasiljevic, San Mateo, CA (US); Dian Chen, San Jose, CA (US); Adrien David Gaidon, San Jose, CA (US); Rares Andrei Ambrus, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/512,938

(22) Filed: Nov. 17, 2023

Related U.S. Application Data
(60) Provisional application No. 63/461,050, filed on Apr. 21, 2023.

(51) Int. Cl. G06T 7/50; G06T 3/40; G06T 7/60; G06V 10/44

(52) U.S. Cl. CPC G06T 7/50; G06T 3/40; G06T 7/60; G06V 10/44

(57) ABSTRACT

Systems, methods, and other embodiments described herein relate to augmenting an image frame during training that enhances scene geometries and transformation capabilities for depth prediction. In one embodiment, a method includes generating rays with camera intrinsics to form a grid for an image frame. The method also includes injecting noise, by an encoder during training of a learning model, to individually perturb pixels within pixel boundaries for the rays, the pixel boundaries defined by the grid. The method also includes removing a subset of the rays randomly by the encoder and extract features from the rays. The method also includes comparing scaled depth estimates to a ground truth for a grid resolution using the features and adjust the learning model from the comparison.

### CROSS-REFERENCE TO RELATED APPLICATIONS

This application claims benefit of U.S. Provisional Application No. 63/461,050, filed on, Apr. 21, 2023, which is herein incorporated by reference in its entirety.

### TECHNICAL FIELD

The subject matter described herein relates, in general, to augmenting an image frame for a depth model, and, more particularly, to augmenting the image frame with scene geometries during training that reduces unwanted effects for a model predicting depth.

### BACKGROUND

Sensors generate data for vehicle systems to perceive other vehicles, obstacles, pedestrians, and additional aspects of a surrounding environment. For example, a vehicle uses a light detection and ranging (LIDAR) sensor that scans the surrounding environment, while logic associated with the LIDAR analyzes acquired data for detecting obstacles, road signs, and so on of the surrounding environment. Similarly, cameras generate data for the vehicle systems to acquire information about the surrounding environment and derive awareness about the surrounding environment. As such, vehicles can perceive depth about the surrounding environment using camera data so that systems such as automated driving systems (ADS) can safely plan and navigate the vehicles through various driving scenarios.

Moreover, vehicles gaining detailed awareness about a surrounding environment assists an operator for driving through diverse conditions and ADSs also can control the vehicle to avoid hazardous encounters, thereby improving safety. However, ADSs using depth estimates outputted by learning models that estimate depth with the camera data encounter difficulties from image transformations. For example, the estimated depth from the learning model loses accuracy when an image is rotated since the transformation was unaccounted for during training. The accuracy may be lost because the learning model was trained on visual characteristics of the image without factoring scene geometries. Accordingly, vehicle systems that rely on depth estimates from learning models using transformed images without representing scene geometries can encounter inaccuracies.

### SUMMARY

In one embodiment, example systems and methods relate to augmenting an image frame during training that enhances scene geometries and transformation capabilities for depth prediction. In various implementations, systems that predict depth from camera data encounter accuracy loss during image transformations (e.g., rotation, flipping, etc.) because of training deficiencies. For example, a system creates geometric gaps when transforming an image from a single camera through rotation since the system lacks camera extrinsics (e.g., pose) and the system was trained using a limited set of camera parameters. As such, the geometric gaps can prohibit predictions in real scales (e.g., metric units) that are transferrable across domains since geometric parameters of cameras vary. Therefore, in one embodiment, a prediction system augments data for an image frame through encoding during training that reduces the appearance and geometric gaps of a model, thereby improving scaled depth estimates. In particular, the prediction system injects noise during training using an encoder of a learning model (e.g., a neural network) that perturbs pixels. Here, the prediction system may use rays generated with camera intrinsics (e.g., focal length, resolution, etc.) for perturbing the pixels. In this way, the learning model reduces unwanted transformation effects during implementation by factoring scene geometrics derived through the camera intrinsics and diversifying acquired data for training. In one approach, the prediction system forms a grid for the image frame and the perturbed pixels are kept within pixel boundaries defined through the grid, thereby allowing data diversification at varying resolutions. Accordingly, the prediction system trains the learning model by scaled depth estimates of the perturbed pixels using interpretable locations within the boundaries with increased accuracy that reduces the transformation effects.

In various implementations, the prediction system removes certain rays randomly by the encoder for further diversifying the augmented data during training. In this way, the rays create expanded observations for a search space of scene features. Furthermore, the learning model compares scaled depth estimates to a ground truth and adjusts the learning model that allows estimates in a real-scale (e.g., metric unit) at different resolutions with the grid. Here, the scaled depth is independent of resolution since the encoding embeds the scene geometries about objects through the ray augmentations. Therefore, the prediction system trains the learning model for estimating scaled depth with increased accuracy and real-scale through data augmentations, thereby improving system robustness.

In one embodiment, a prediction system for augmenting an image frame during training that enhances scene geometries and transformation capabilities for depth prediction is disclosed. The prediction system includes a memory storing instructions that, when executed by a processor, cause the processor to generate rays with camera intrinsics to form a grid for an image frame. The instructions also include instructions to inject noise, by an encoder during training of a learning model, to individually perturb pixels within pixel boundaries for the rays, the pixel boundaries defined by the grid. The instructions also include instructions to remove a subset of the rays randomly by the encoder and extract features from the rays. The instructions also include instructions to compare scaled depth estimates to a ground truth for a grid resolution using the features and adjust the learning model from the comparison.

In one embodiment, a non-transitory computer-readable medium for augmenting an image frame during training that enhances scene geometries and transformation capabilities for depth prediction and including instructions that when executed by a processor cause the processor to perform one or more functions is disclosed. The instructions include instructions to generate rays with camera intrinsics to form a grid for an image frame. The instructions also include instructions to inject noise, by an encoder during training of a learning model, to individually perturb pixels within pixel boundaries for the rays, the pixel boundaries defined by the grid. The instructions also include instructions to remove a subset of the rays randomly by the encoder and extract features from the rays. The instructions also include instructions to compare scaled depth estimates to a ground truth for a grid resolution using the features and adjust the learning model from the comparison.

In one embodiment, a method for augmenting an image frame during training that enhances scene geometries and transformation capabilities for depth prediction is disclosed. In one embodiment, the method includes generating rays with camera intrinsics to form a grid for an image frame. The method also includes injecting noise, by an encoder during training of a learning model, to individually perturb pixels within pixel boundaries for the rays, the pixel boundaries defined by the grid. The method also includes removing a subset of the rays randomly by the encoder and extract features from the rays. The method also includes comparing scaled depth estimates to a ground truth for a grid resolution using the features and adjust the learning model from the comparison.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with augmenting an image frame with scene geometries during training that reduces transformation errors involving depth prediction.

FIG. 3 illustrates one embodiment of the prediction system augmenting rays of the image frame in a grid by perturbing pixels during training.

FIG. 4 illustrates one embodiment of a method that is associated with the prediction system generating rays associated with the image frame and injecting noise to perturb pixels during training for estimating scaled depth.

FIG. 5 illustrates an example of a vehicle implementing the prediction system on a road for estimating scaled depth using camera data.

### DETAILED DESCRIPTION

Systems, methods, and other embodiments associated with augmenting an image frame during training that enhances scene geometries and transformation capabilities for depth prediction are disclosed herein. In various implementations, systems predicting depth encounter geometric gaps when transforming (e.g., rotation, flipping, etc.) an image generated with a single camera from training limitations. The geometric gaps can prohibit predictions in real scales (e.g., metric units) and correspondingly transferability of datasets across domains since geometric parameters for cameras vary. As such, systems may augment the visual characteristics of camera data during training for robustness. However, augmenting the visual characteristics without factoring scene geometries can limit the capabilities and robustness for depth prediction by a learning model.

Therefore, in one embodiment, a prediction system generates rays with camera intrinsics (e.g., focal length, resolution, etc.) for forming an image frame and injects noise using a learning model (e.g., a neural network) during training to perturb pixels derived from the rays. In particular, the image frame may be in a grid form and the rays are perturbed randomly using an encoder of the learning model within pixel boundaries defined by the grid. In this way, the prediction system augments the image frame with scene geometries and additional data without additional computation costs that improves estimating scaled depth in a real-scale (e.g., metric units). Furthermore, the learning model accurately predicts depths for zero-shot transfer involving objects within a scene unobserved during the training. Accordingly, the prediction system improves depth prediction of the learning model by augmenting pixel data with noise and scene geometries during training while containing computation costs.

In various implementations, the prediction system moves the rays from the centers of the pixel boundaries to increase ray types representing different geometries for objects during training. The prediction system may then remove rays randomly while factoring the ray type, thereby improving data diversity for encoding and reducing computational complexity. In one approach, the learning model identifies features about objects by the learning model using known priors (i.e., initial assumptions about data) that factor appearance characteristics of the objects along with the ray types. In this way, the learning model executes zero-shot learning during implementation by reducing geometric gaps from unknown priors and camera parameters (e.g., focal length, resolution, etc.) that vary for different hardware systems.

Moreover, the prediction system can enhance training diversity by interpolating between the centers of the pixel boundaries and the pixels. As such, the prediction system can interpret context about the location of the features while including the noise. Regarding adjusting the learning model, the prediction system may compare scaled depth estimates inferred from the features against a ground truth (i.e., real measurements of scaled depth) and update weights of the learning model through back-propagation. Therefore, the prediction system trains a learning model that predicts depth in a real-scale for unknown objects by augmenting image data, thereby improving system robustness.

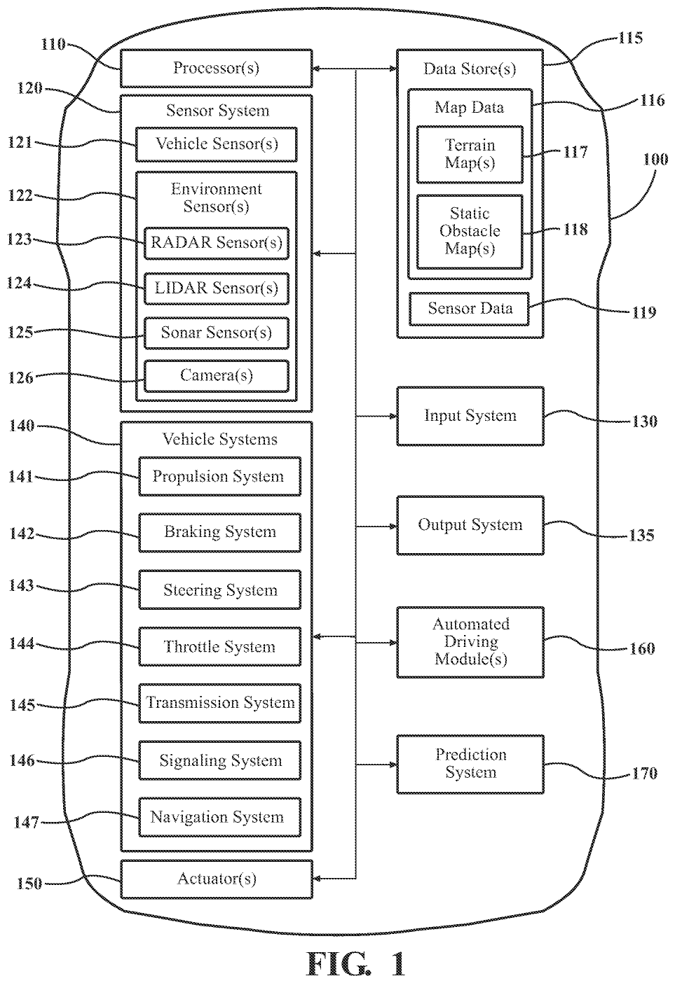

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, a server, an edge computer, and so on that benefit from the functionality discussed herein associated with augmenting an image frame during training that enhances scene geometries and transformation capabilities for depth prediction.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, one or more components of the disclosed system can be implemented within a vehicle while further components of the system are implemented within a cloud-computing environment or other system that is remote from the vehicle 100.

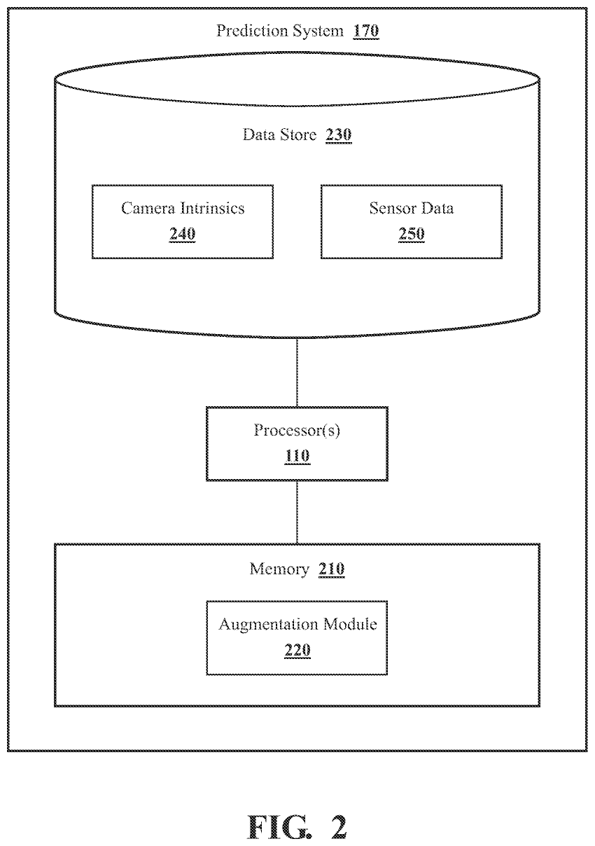

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to augmenting an image frame during training that enhances scene geometries and transformation capabilities for depth prediction.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores an augmentation module 220. The memory 210 is a random-access memory (RAM), a read-only memory (ROM), a hard-disk drive, a flash memory, or other suitable memory for storing the augmentation module 220. The augmentation module 220 is, for example, computer-readable instructions that when executed by the processor(s) 110 cause the processor(s) 110 to perform the various functions disclosed herein.

Moreover, the augmentation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the augmentation module 220, in one embodiment, acquires the sensor data 250 that includes at least camera images for training a learning model. In further arrangements, the augmentation module 220 acquires the sensor data 250 from further sensors such as radar sensors 123, LIDAR sensors 124, and other sensors as may be suitable for identifying vehicles and locations of the vehicles.

Accordingly, the augmentation module 220, in one embodiment, controls the respective sensors to provide the data inputs in the form of the sensor data 250. Additionally, while the augmentation module 220 is discussed as controlling the various sensors to provide the sensor data 250, in one or more embodiments, the augmentation module 220 can employ other techniques to acquire the sensor data 250 that are either active or passive. For example, the augmentation module 220 may passively sniff the sensor data 250 from a stream of electronic information provided by the various sensors to further components within the vehicle 100. Moreover, the augmentation module 220 can undertake various approaches to fuse data from multiple sensors when providing the sensor data 250 and/or from sensor data acquired over a wireless communication link.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the augmentation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on.

In one embodiment, the data store 230 further includes the camera intrinsics 240 describing a focal length, an aperture, an orientation, a field-of-view, a resolution, and so on for camera hardware. Here, these properties are processed by the prediction system 170 as geometric embeddings instead of using raw values about the camera hardware. In this way, the prediction system 170 simplifies computations by using values associated with these properties for estimating scaled depth maps instead of raw values. In addition, as explained below, the prediction system 170 processes the camera intrinsics 240 so that encoding by a learning model (e.g., a neural network) embeds scene geometries that improve depth estimates.

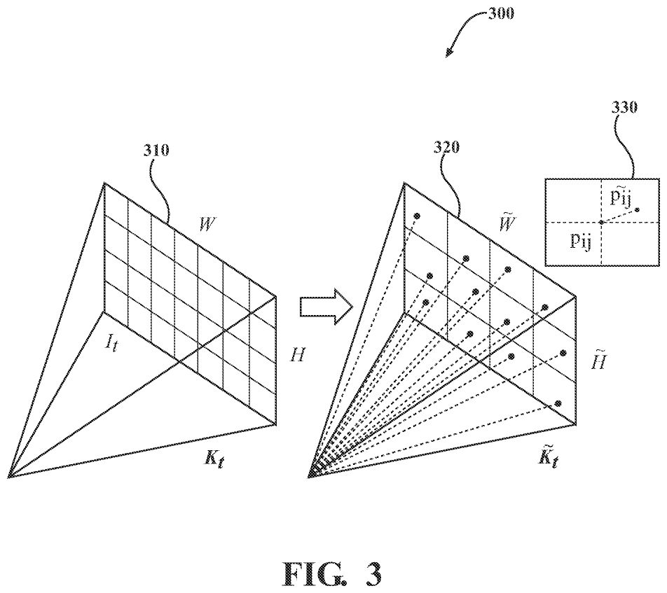

Now referring to FIG. 3, one embodiment of the prediction system 170 augmenting rays of an image frame in a grid by perturbing pixels 300 during training is illustrated. Here, the augmentation module 220, in one embodiment, is further configured to perform additional tasks beyond controlling the respective sensors to acquire and provide the sensor data 250. For example, the augmentation module 220 includes instructions that cause the processor(s) 110 to modify inputs associated with encoding so that a learning model trains using an expanded search space of observations and features about objects within a scene, thereby improving depth estimates during implementation. Furthermore, training a learning model by diversifying samples can decouple encoding from decoding, thus forgoing decoder modifications and simplifying learning models. In this way, the learning model can decode depth estimates from scene geometries not encoded, thereby allowing zero-shot learning for robust performance.

Moreover, data augmentation produces robustness that allows the learning model to accurately predict depth regardless of image transformations. For example, the learning model is capable of estimating depth of an animal within an image independent of orientation (e.g., flipped, rotated, translated, darkened, etc.) that otherwise leaves the animal unchanged. However, the prediction system 170 relying on visual characteristics without incorporating scene geometries can encounter losses. This may occur when portions of the image frame are removed because of insufficient data.

In FIG. 3, the prediction system 170 generates rays with the camera intrinsics 240 and forms a grid for an acquired image frame 310 that trains the learning model to predict depth while reducing transformation errors. Although the examples given in FIG. 3 are directed towards training for a single-camera system, the augmentation principles similarly apply to multiple-camera systems that acquire camera data from multiple sources for depth predictions. Here, the camera intrinsics 240 conditions the learning model for training to derive a metric scale while reducing computational costs when generating the rays. The learning model may have an encoder that injects noise perturbing a pixel(s) within pixel boundaries for acquired rays of light. For example, the pixel boundaries are defined by the grid for the acquired image frame 310 that has dimensions height (H)×width (W). The noisy pixels may be kept within the pixel boundaries so that extracted features have context when object characteristics are correlated with the original pixel during the training.

In one approach, the injection involves moving the rays from the centers of the pixel boundaries to increase ray types in three dimensions (3D). Here, the ray types can represent different geometries for objects within the scene such as circular, square, and so on. For interpreting depth for locations having noise, the prediction system 170 interpolates between the centers and the offset pixels to reason geometric relationships between the pixel points. In this way, the prediction system 170 increases sample diversity during training for feature extraction through factoring ray types, thereby improving depth estimates independent of camera parameters (e.g., focal length, resolution, etc.) when the learning model is implemented.

Furthermore, the encoder may remove a subset of the rays randomly before or after noise injection. In this case, the image frame 320 may be represented by dimensions \tilde{H}×\tilde{W}. Here, the random dropout may allow the prediction system 170 to train robustly using latent representations having scene-level data (e.g., image features, geometric features, etc.) that causes the learning model to reason over dense predictions that are conditioned with partial inputs. This approach expands a search space for features by the encoder resizing the acquired image frame 310 randomly, thereby allowing the learning module to share depth predictions across different scenes (i.e., globally) during implementation. Also, the prediction system 170 can train using depth estimates for an entire scene from a portion of the image frame 320, thereby reducing computation costs while increasing training effectiveness. In one approach, the prediction system 170 drops the rays selectively by ray types and a pattern. Through selective dropout, the augmentation module 220 can coarsely add data while significantly reducing training costs.

Regarding details on injecting noise, the prediction system 170 assumes having pixel coordinates at pᵢⱼ 330 and camera intrinsics Kₜ for an image resolution such that Kₜ is appropriately scaled. However, image embeddings (e.g., color, brightness, etc.) used when the learning model is implemented can vary with resolution when relying on visual characteristics and fixed receptive fields. Here, the image embeddings represent visual characteristics about the image frame 320 without using raw values that can limit zero-shot learning as resolution varies during implementation. As such, the prediction system 170 randomly resize images during training from H×W to \tilde{H}×\tilde{W} modifying the features used by the learning model as image embeddings for encoding during training that improves implementation. Furthermore, the prediction system 170 preserves the 3D scene structure for maintaining a real scale (e.g., metric scale) by modifying camera intrinsics, such that:

$${\overline{K}}_{t} = [ \begin{matrix}{r}_{w} {f}_{x} & 0 & {r}_{w} ( {c}_{x} - 0.5 ) + 0.5 \\ 0 & {r}_{h} {f}_{y} & {r}_{h} ( {c}_{y} - 0.5 ) + 0.5 \\ 0 & & 1\end{matrix} ] . \qquad Equation ( 1 )$$

where r_{w}=\tilde{W}/W and rₕ=\tilde{H}/W are, respectively the width and height resizing ratios.

In Equation (1), parameters fₓ and f_{y} represent focal lengths from a pinhole model. Parameters cₓ and c_{y} are principal points associated with an image center. In various implementations, a pinhole model forms a mathematical relationship between the coordinates of a point in 3D space and projecting the point onto an image plane associated with an ideal pinhole camera. The pinhole model represents a camera aperture as a point (i.e., minimal aperture) and excludes lenses for focusing light. Furthermore, the pinhole model excludes geometric distortions from unfocused objects caused by lenses and finite apertures. The pinhold model also disregards discrete image coordinates. Therefore, a pinhole camera model is used as a first-order approximation of the mapping from a 3D scene to a 2D image.

Still referring to FIG. 3, the prediction system 170 injects jitter to rays for augmenting the search space during training. Regarding details on injecting noise, the prediction system 170 expands diversity by perturbing pᵢⱼ 330 with uniform noise (e.g., [−0.5, 0.5]) such that the new location \tilde{p}ᵢⱼ is still within the pixel boundaries of the image frame 320. Here, the perturbation may be random or semi-random by factoring image parameters (e.g., color, brightness, etc.) using uniform noise. In this way, the learning model trains with diverse data that is expanded through geometric embeddings. This also increases the transfer capability of the learning model across different resolutions and camera parameters during implementation. Furthermore, the prediction system 170 can compute the geometric embeddings using two-dimensional (2D) pixel coordinates pᵢⱼ at the center. This allows generating similar geometric embeddings for images with having resolution y and camera intrinsics. Corresponding image embeddings ε_{I} are generated by bilinearly interpolating image features in these new coordinates for matching location with the rays.

In various implementations, the prediction system 170 trains the learning model by injecting jitter to resolution. For example, the prediction system 170 randomly resizes the acquired image frame 310 to resolutions in a range (e.g., between 25% and 150%) of the original H×W. The height and width dimensions may be independently resized and the prediction system 170 utilizes multiples for sampled resolutions factor network capabilities. Furthermore, the prediction system 170 may also perturb noise associated with the acquired image frame 310 that improves training accuracy and robustness for various camera types during inference. For embedding dropout, the prediction system 170 randomly selects encoder embeddings between a range (e.g., 0% and 50%) to remove at each training iteration, such as by factoring image parameters (e.g., color, brightness, etc.). In this way, resolution jittering produces a discontinuous distribution of rays over a search space using a discrete image frame, thereby improving data augmentation and diversity for training the learning model.

Regarding loss calculations from training, the prediction system 170 may compute deep loss through supervision by comparing scale depth estimated to a ground truth (i.e., real measurements of scaled depth). The prediction system 170 can compute errors and update weights of the learning model that improves robustness of estimating scaled depth for zero-shot learning independent of camera types. For example, the prediction system 170 back propagates depth estimates iteratively by evaluating the derivative of a cost function as product derivatives between network layers (e.g., neural network layers) from right-to-left with weight gradients between each layer. Here, the weight gradients may be a modification of the partial products that represent the backwards propagated error. Therefore, the prediction system 170 improves depth estimates during inference by training the learning model using back-propagation and augmented inputs.

Now turning to inference, the prediction system 170 acquires an image frame for estimating scaled depth by a learning model (e.g., a CNN) of objects within a scene. Through the training described above, the scaled depth computations are accurate for various resolutions associated with the image frame. Furthermore, the transformation (e.g., rotation) through orientation is unaffected because the learning model factors varying geometries of camera types with the training. As such, the prediction system 170 can transfer scale priors to a vehicle having a sensor that acquires an image dataset, even though the sensor has geometric properties that differ from the camera intrinsics 240.

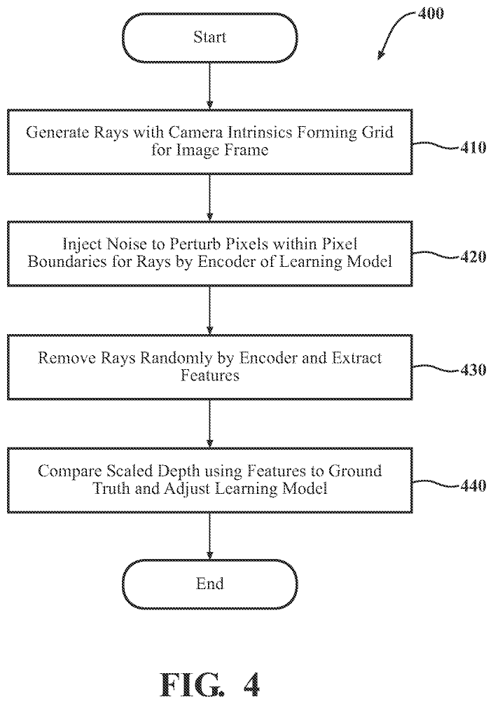

Now turning to FIG. 4, a flowchart of a method 400 that is associated with the prediction system generating rays associated with the image frame and injecting noise to perturb pixels during training for estimating scaled depth is illustrated. The method 400 will be discussed from the perspective of the prediction system 170 of FIGS. 1, and 2. While the method 400 is discussed in combination with the prediction system 170, it should be appreciated that the method 400 is not limited to being implemented within the prediction system 170 but is instead one example of a system that may implement the method 400.

At 410, the prediction system 170 generates rays with the camera intrinsics 240 and forms a grid for an image frame. As previously explained, the augmentation principles in method 400 apply to single-camera and multiple-camera systems for training a learning model to accurately estimate scaled depth across varying camera parameters (e.g., focal length, resolution, etc.). Here, the prediction system 170 pre-processes image data with the camera intrinsics 240 to condition the learning model for training that reduces computational costs when generating the rays by limiting unknown parameters. Furthermore, the learning model may have an encoder that injects noise perturbing pixels within pixel boundaries for the rays. The pixel boundaries can be defined by the grid for the image frame with dimensions height (H)×width (W). In one approach, the noisy pixels are kept within the pixel boundaries of the grid so that extracted features have context when object characteristics are correlated with the original pixel during training, thereby improving adjustments for the learning model.

At step 420, the augmentation module 220 injects noise to perturb the pixels within the pixel boundaries for the rays by the encoder of the learning model. Here, the injection may involve moving the rays from the centers of the pixel boundaries to increase ray types in 3D. The ray types can represent different geometries for objects within the scene such as circular, square, and so on. In one approach, the prediction system 170 interpolates between the centers and the offset pixels to reason geometric relationships between the pixel points for interpreting depth for locations having noise. In this way, the prediction system 170 increases sample diversity during training for feature extraction through factoring ray types, thereby improving depth estimates independent of camera parameters (e.g., focal length, resolution, etc.) when the learning model is implemented.

In various implementations, the prediction system 170 injects jitter to rays for augmenting the search space during training using uniform noise. Here, the noise may be injected while keeping the new pixel location within the pixel boundaries of the image frame to maintain relationships and correlations between pixels for depth estimation. Furthermore, the perturbation may be random or semi-random by factoring image parameters (e.g., color, brightness, etc.) using the uniform noise. In this way, the learning model can train with diverse data that is expanded and when combined with geometric embeddings, increases transfer capability of the learning model across different resolutions and camera parameters during implementation.

Moreover, the geometric embeddings use 2D pixel coordinates at the center that allows generating similar geometric embeddings for images with having resolution y and camera intrinsics. Here, corresponding image embeddings are generated by bilinearly interpolating image features in these new coordinates for matching location with the rays. Accordingly, the prediction system 170 expands search and augmentation robustness through injecting jitter and factoring geometric embedding during training that improves the transferability of scaled depth at implementation.

In one approach, the prediction system 170 trains the learning model by injecting jitter to resolution. In this case, as previously explained, the prediction system 170 can randomly resize the image frame to resolutions in a range (e.g., between 25% and 150%) of the original H×W. For embedding dropout, the prediction system 170 randomly selects encoder embeddings between a range (e.g., 0% and 50%) to remove at each training iteration, such as by factoring image parameters (e.g., color, brightness, etc.). Accordingly, resolution jittering produces a discontinuous distribution of rays over a search space using a discrete image frame, thereby improving data augmentation and diversity for training the learning model similar to injecting noise to pixels.

At 430, the prediction system 170 remove rays randomly by the encoder and extract features. Here, the encoder may remove a subset of the rays randomly associated with injecting noise. The random dropout can allow the prediction system 170 to train robustly using latent representations having scene-level data (e.g., image features, geometric features, etc.) that causes the learning model to reason over dense predictions that are conditioned with partial inputs. This approach expands a search space for features by the encoder resizing the image frame randomly, thereby allowing the learning module to share depth predictions across different scenes (i.e., globally) during implementation. Furthermore, the prediction system 170 trains using depth estimates for an entire scene from a portion of the image frame 320, thereby reducing computation costs while increasing training effectiveness.

At 440, the prediction system 170 compares the scaled depth using the features to the ground truth and adjusts the learning model. Here, the prediction system 170 can compute errors and update weights of the learning model according to resolution. As such, this improves robustness of estimating scaled depth for zero-shot learning independent of camera types. As previously explained, the prediction system 170 can back propagate depth estimates iteratively by evaluating the derivative of a cost function as product derivatives between network layers (e.g., neural network layers) from right-to-left with the weight gradients between each layer. In particular, the weight gradients may be a modification of the partial products that represent the backward propagated error. In this way, the prediction system 170 robustly trains the learning model using back propagation and augmented inputs that improves depth estimates during inference.

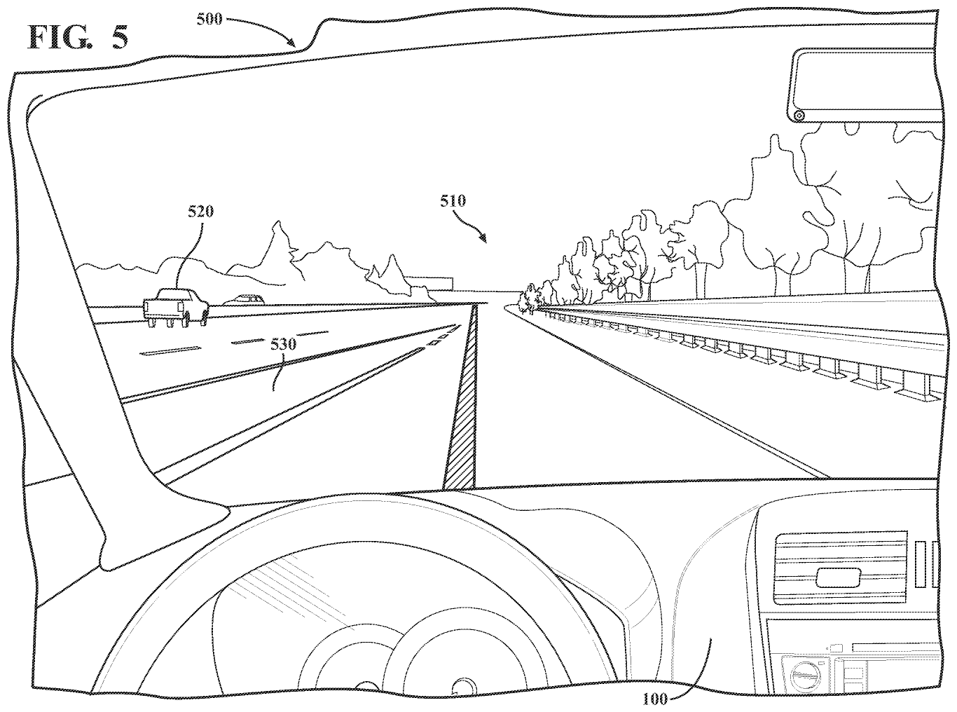

Now turning to FIG. 5, an example of the vehicle 100 implementing the prediction system 170 in a driving scenario 500 for estimating scaled depth using camera data is illustrated. In one approach, the vehicle 100 traveling on road 530 including truck 520 acquires an image frame of the scene 510 for estimating scaled depth by a learning model (e.g., a CNN). The prediction system 170 trains the learning model so that the scaled depth computations are accurate for various resolutions associated with the image frame. As previously explained, the transformation (e.g., rotation) through orientation is unaffected because the learning model factors varying geometries of camera types through the training. As such, the prediction system 170 can transfer scale priors to the truck 520 having a sensor that acquires an image dataset, even though the sensor has geometric properties that differ from the camera intrinsics 240. Therefore, the prediction system 170 trains the learning model for estimating scaled depth accurately through data augmentations and noise injections, thereby improving system robustness and prediction portability.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5 but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
generate rays with camera intrinsics to form a grid for an image frame;
inject noise, by an encoder during training of a learning model, to individually perturb pixels within pixel boundaries for the rays, the pixel boundaries defined by the grid;
remove a subset of the rays randomly by the encoder and extract features from the rays; and
compare scaled depth estimates to a ground truth for a grid resolution using the features and adjust the learning model from the comparison.

2. The prediction system of claim 1, wherein the instructions to inject the noise further include to:
move the rays from centers of the pixel boundaries to increase ray types in three dimensions, the ray types representing different geometries for objects within the image frame.

3. The prediction system of claim 1, wherein the instructions to compare the scaled depth further include to:
identify the features about objects within the image frame by the learning model using known priors representing appearance characteristics about the objects without depth information.

4. The prediction system of claim 3 further including instructions to:
interpolate between centers of the pixel boundaries and the pixels for interpreting location of the features including the noise.

5. The prediction system of claim 3, wherein the rays include expanded observations for a search space of the features and the scaled depth is independent of different resolutions.

6. The prediction system of claim 1 further including instructions to:
transfer scale priors estimated during implementation to a vehicle having a sensor that acquires an image dataset, wherein the sensor has geometric properties that differ from the camera intrinsics.

7. The prediction system of claim 6 further including instructions to:
transform the image dataset by rotation without perturbations of the image dataset.

8. The prediction system of claim 1, wherein the instructions to compare the scaled depth further include to:
interpolate the features for generating image embeddings using the rays, the image embeddings associated with visual characteristics about the image frame; and
execute back-propagation to adjust weights of the learning model from losses between the scaled depth estimates to the ground truth, and the ground truth has real depth measurements about objects within the image frame.

9. The prediction system of claim 1, wherein the instructions to remove the subset of the rays further include to:
expand a search space for the features by the encoder resizing the image frame randomly, the search space including latent representations about the image frame.

10. A non-transitory computer-readable medium comprising:
instructions that when executed by a processor cause the processor to:
generate rays with camera intrinsics to form a grid for an image frame;
inject noise, by an encoder during training of a learning model, to individually perturb pixels within pixel boundaries for the rays, the pixel boundaries defined by the grid;
remove a subset of the rays randomly by the encoder and extract features from the rays; and
compare scaled depth estimates to a ground truth for a grid resolution using the features and adjust the learning model from the comparison.

11. The non-transitory computer-readable medium of claim 10, wherein the instructions to inject the noise further include to:
move the rays from centers of the pixel boundaries to increase ray types in three dimensions, the ray types representing different geometries for objects within the image frame.

12. A method comprising:
generating rays with camera intrinsics to form a grid for an image frame;
injecting noise, by an encoder during training of a learning model, to individually perturb pixels within pixel boundaries for the rays, the pixel boundaries defined by the grid;
removing a subset of the rays randomly by the encoder and extract features from the rays; and
comparing scaled depth estimates to a ground truth for a grid resolution using the features and adjust the learning model from the comparison.

13. The method of claim 12, wherein injecting the noise further includes:
moving the rays from centers of the pixel boundaries to increase ray types in three dimensions, the ray types representing different geometries for objects within the image frame.

14. The method of claim 12, wherein estimating the scaled depth further includes:
identifying the features about objects within the image frame by the learning model using known priors representing appearance characteristics about the objects without depth information.

15. The method of claim 14 further comprising:
interpolating between centers of the pixel boundaries and the pixels for interpreting location of the features including the noise.

16. The method of claim 14, wherein the rays include expanded observations for a search space of the features and the scaled depth is independent of different resolutions.

17. The method of claim 12 further comprising:
transferring scale priors estimated during implementation to a vehicle having a sensor that acquires an image dataset, wherein the sensor has geometric properties that differ from the camera intrinsics.

18. The method of claim 17 further comprising:
transforming the image dataset by rotation without perturbations of the image dataset.

19. The method of claim 12 further comprising:
interpolating the features for generating image embeddings using the rays, the image embeddings associated with visual characteristics about the image frame; and
executing back-propagation to adjust weights of the learning model from losses between the scaled depth estimates to the ground truth, and the ground truth has real depth measurements about objects within the image frame.

20. The method of claim 12, wherein removing the rays further includes:
expanding a search space for features by the encoder resizing the image frame randomly, the search space including latent representations about the image frame.
